(19) United States
(12) Patent Application Publication
(10) Pub. No.: US 2019/0316618 A1
(43) Pub. Date: Oct. 17, 2019

(54) DISPLAY MECHANISM OF A PNEUMATIC TOOL

(71) Applicant: Ming-Ta CHENG, Taichung City (TW)

(72) Inventor: Ming-Ta CHENG, Taichung City (TW)

(21) Appl. No.: 15/954,579

(22) Filed: Apr. 16, 2018

(51) Int. Cl. F16B 7/18

(52) U.S. Cl. CPC F16B 7/182

(57) ABSTRACT

A display mechanism of a pneumatic tool has a holding element, an operating element, and a display portion. The holding element has a surrounding wall, a display recess, a spacer slice, and a mounting recess. The display recess is formed in a top surface of the surrounding wall. The spacer slice is mounted on an inner surface of the surrounding wall. The mounting recess is formed between the surrounding wall of the holding element and the spacer slice. A bottom portion of the operating element is inserted into and is screwed with a top portion of the holding element. The operating portion has a thread portion, a rotating portion, and a receiving slice. The display portion is attached to the wall of the receiving recess of the receiving slice. The display portion has multiple display marks formed in an outer surface of the display portion.

### BACKGROUND OF THE INVENTION

### 1. Field of the Invention

The invention relates to a display mechanism, and more particularly to a display mechanism of a pneumatic tool which has an expended lifespan.

### 2. Description of Related Art

A pneumatic tool is a tool that uses compressed air as a power source. The conventional pneumatic tool has a holding element and an operating element. The operating element may be rotated relative to the holding element, and this may control the volume and the direction of the compressed air. In order to know the direction of the compressed air, a display mechanism of the conventional pneumatic tool is directly engraved on an outer surface of the operating element.

As the display mechanism of the conventional pneumatic tool is directly engraved on an outer surface of the operating element, the display mechanism would wear off due to long time use.

To overcome the shortcomings of the conventional display mechanism of a pneumatic tool, the present invention provides a display mechanism of a pneumatic tool to mitigate or obviate the aforementioned problems.

### SUMMARY OF THE INVENTION

The main objective of the present invention is to provide a display mechanism of a pneumatic tool that can extend the service life.

The display mechanism of a pneumatic tool has a holding element, an operating element, and a display portion. The holding element has a surrounding wall, a display recess, a spacer slice, and a mounting recess. The display recess is formed in a top surface of the surrounding wall. The spacer slice is mounted on an inner surface of the surrounding wall. The mounting recess is formed between the surrounding wall of the holding element and the spacer slice. A bottom portion of the operating element is inserted into and is screwed with a top portion of the holding element. The operating portion has a thread portion, a rotating portion, and a receiving slice. The display portion is attached to the wall of the receiving recess of the receiving slice. The display portion has multiple display marks engraved on an outer surface of the display portion.

Other objects, advantages, and novel features of the invention will become more apparent from the following detailed description when taken in conjunction with the accompanying drawings.

### BRIEF DESCRIPTION OF THE DRAWINGS

FIG. 1 is a perspective view of a first embodiment of a display mechanism of a pneumatic tool in accordance with the present invention;

FIG. 2 is an exploded perspective view of the display mechanism of the pneumatic tool in FIG. 1;

FIG. 3 is an enlarged cross sectional top view of the display mechanism of the pneumatic tool in FIG. 1;

FIG. 4 is a front view of the display mechanism of the pneumatic tool in FIG. 1;

FIG. 5 is an operational front view of the display mechanism of the pneumatic tool in FIG. 1;

FIG. 6 is an exploded perspective view of a second embodiment of a display mechanism of a pneumatic tool in accordance with the present invention.

### DETAILED DESCRIPTION OF PREFERRED EMBODIMENT

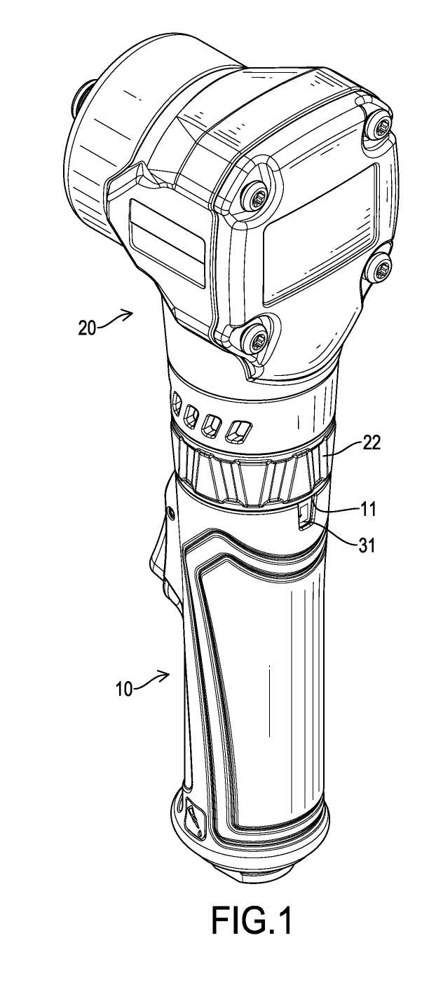

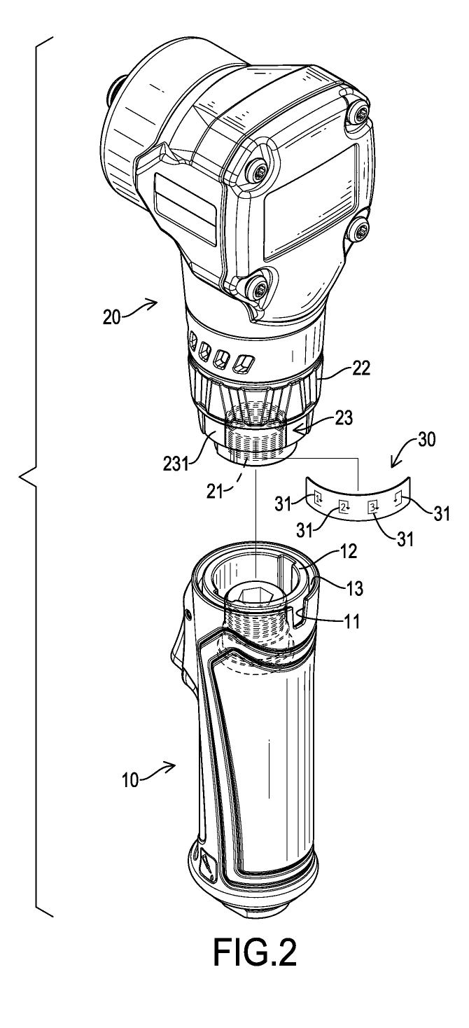

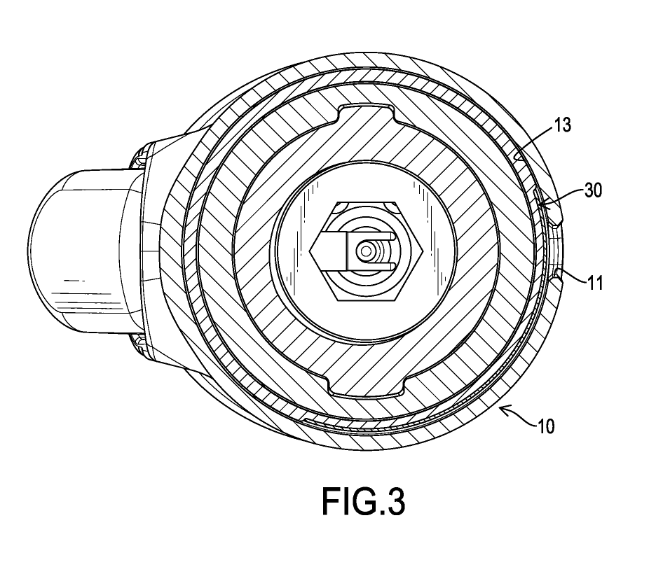

With reference to FIGS. 1 to 3, a display mechanism of a pneumatic tool of a first embodiment in accordance with the present invention comprises a holding element 10, an operating element 20, and a display portion 30.

The holding element 10 is a rod and has a surrounding wall, a display recess 11, a spacer slice 12, and a mounting recess 13. The display recess 11 is formed in a top surface of the surrounding wall. The spacer slice 12 is mounted on an inner surface of the surrounding wall, and the spacer slice 12 is at a spaced interval with the surrounding wall. The mounting recess 13 is formed between the surrounding wall of the holding element 10 and the spacer slice 12.

A bottom portion of the operating element 20 is inserted into and is screwed with a top portion of the holding element 10. The operating portion 20 has a thread portion 21, a rotating portion 22, and a receiving slice 23. The thread portion 21 protrudes downward from the bottom of the operating element 20. The rotating portion 22 radially protrudes from an outer surface of the operating element 20. The receiving slice 23 protrudes downward from a bottom edge of the rotating portion 22, and is rotatably inserted into the mounting recess 13 of the holding element 10. The receiving slice 23 has a receiving recess 231 radially formed in a bottom surface of the receiving slice 23.

The display portion 30 is attached to a wall of the receiving recess 231 of the receiving slice 23, and is inserted into the mounting recess 13 of the holding element 10. The display portion 30 has multiple display marks 31 formed in an outer surface of the display portion 30. The multiple display marks 31 are disposed at spaced intervals, and this facilitates a user to check the multiple display marks 31 via the display recess 11.

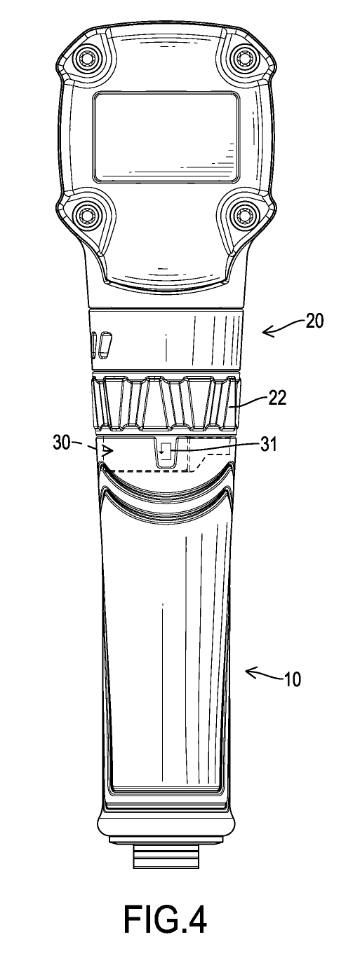

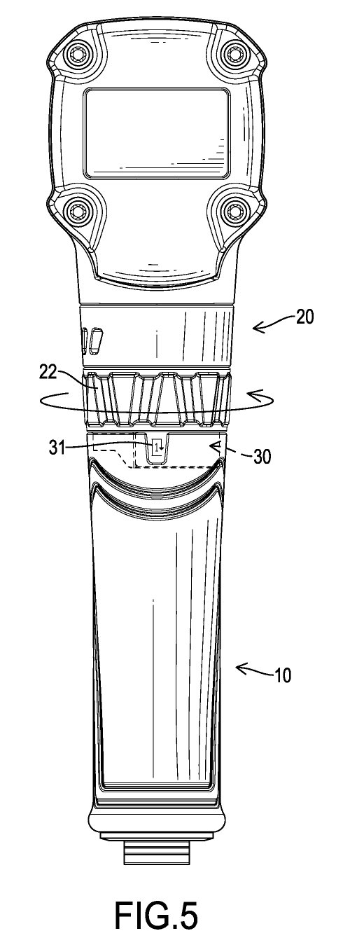

With reference to FIGS. 4 and 5, when the display mechanism of a pneumatic tool in accordance with the present invention is in use, the user holds the holding element 10 with one hand, and rotates the rotating portion 22 of the operating element 20 with the other hand The multiple display marks 31 can be shown to the user via the display recess 11. The display mechanism of the conventional pneumatic tool is directly engraved on an outer surface of the operating element and the display mechanism would wear off over time. In the display mechanism of a pneumatic tool in accordance with the present invention, the display portion 30 is inserted into the mounting recess 13 of the holding element 10. Therefore, the multiple display marks 31 may be protected by the mounting recess 13, and this may prevent the multiple display marks 31 from wearing off after long time use. In addition, the lifespan of the display mechanism of a pneumatic tool in accordance with the present invention can be extended.

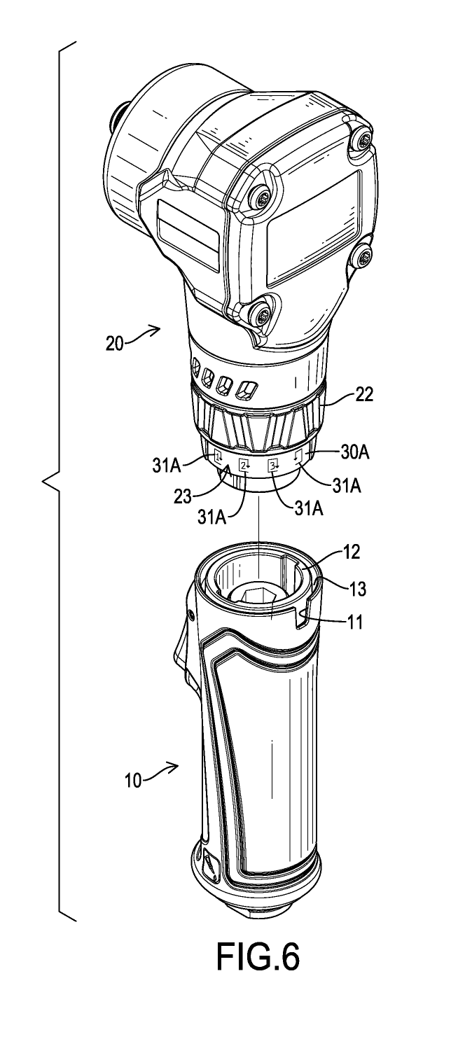

With reference to FIG. 6, a second embodiment of a display mechanism of a pneumatic tool in accordance with the present invention is substantially the same as the first embodiment except for the following feature. The multiple display marks 31A of the display portion 30 are formed on the receiving slice 23.

Even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A display mechanism of a pneumatic tool comprising:
a holding element having
a surrounding wall;
a display recess formed in a top surface of the surrounding wall;
a spacer slice mounted on an inner surface of the surrounding wall and located at a spaced interval with the surrounding wall; and
a mounting recess formed between the surrounding wall of the holding element and the spacer slice;
an operating element inserted into and screwed with a top portion of the holding element and having
a thread portion protruding downward from a bottom of the operating element; and
a receiving slice protruding downward from a bottom edge of the operating element, rotatably inserted into the mounting recess of the holding element, and having a receiving recess radially formed in a bottom surface of the receiving slice;
a display portion attached to a wall of the receiving recess of the receiving slice, inserted into the mounting recess of the holding element, and having
multiple display marks disposed at intervals.

2. The display mechanism of a pneumatic tool as claimed in claim 1, wherein the operating element has a rotating portion radially protruding from an outer surface of the operating element, and located at a top edge of the receiving slice.
